(19) United States
(12) Patent Application Publication
(10) Pub. No.: US 2011/0050103 A1
(43) Pub. Date: Mar. 3, 2011

(54) Led lamp having heat-dissipating device

(75) Inventor: Sander Lye, Taipei (TW)

(73) Assignee: STAR RIGHT LIMITED, Hong Kong (CN)

(21) Appl. No.: 12/805,057

(22) Filed: Jul. 9, 2010

Related U.S. Application Data
(63) Continuation of application No. 12/461,887, filed on Aug. 27, 2009.

(51) Int. Cl. H01J 13/32; H01J 61/52

(52) U.S. Cl. 315/113; 315/112

(57) ABSTRACT

An LED lamp includes a columnar heat-dissipating member having at least one air passage axially running through its inside; a cooling fan mounted to the heat-dissipating member and to a top end of the air passage; at least one LED disposed on a surface of the heat-dissipating member; and a controller electrically connected with the cooling fan and the LED for enabling the cooling fan to drive the airflow to flow upward and for driving the LED to light up.

### BACKGROUND OF THE INVENTION

1. Field of the Invention

The present invention relates generally to cooling devices applied to illuminators, and more particularly, to an LED lamp having a heat-dissipating device.

2. Description of the Related Art

In the field of solid-state lighting (SSL), a light-emitting diode (LED) includes the advantages of small size, long working time, no mercury, and low energy consumption. As the brightness of the LED keeps enhanced, the lighting apparatuses based on the LED have been available in commerce and are expected to replace the conventional tungsten, halogen, and fluorescent lamps for saving energy and reducing carbon dioxide. However, because the photoelectric conversion efficiency of the LED is limited, while a high-power LED is working, a great amount of heat will be generated. If such heat cannot be effectively dissipated, it will bring serious negative effect on the photoelectric property of the LED and then thermally damage the LED.

In light of the problem mentioned above, there was an improved lighting apparatus having a heat-dissipating plate, an LED mounted to a bottom side of the heat-dissipating plate, and a plurality of fins mounted to a top side or a lateral side of the heat-dissipating plate. The heat generated by the LED can be conducted through the heat-dissipating plate to the fins and the air passing by the fins can take the heat away, thus resulting in thermal dissipation. However, the effect of such thermal dissipation is not satisfactory because the airflow resistance between the fins is large. Besides, while the fins absorb the heat, they fail to dissipate the same and even worse to dissipate the heat of the LED. Such circumstances often happen on LED lamps mounted outdoors.

### SUMMARY OF THE INVENTION

The primary objective of the present invention is to provide an LED lamp, whose thermal dissipation is based on preferable natural convection.

The secondary objective of the present invention is to provide an LED lamp, which still keeps thermal dissipation while external heat is transferred thereto.

The foregoing objectives of the present invention are attained by the LED lamp composed of a columnar heat-dissipating member having at least one air passage axially running through its inside; a cooling fan mounted to the heat-dissipating member and to a top end of the air passage; at least one LED disposed on a surface of the heat-dissipating member; and a controller electrically connected with the cooling fan and the LED for enabling the cooling fan to drive the airflow to flow upward and for driving the LED to light up.

### BRIEF DESCRIPTION OF THE DRAWINGS

FIG. 1 is a schematic view of a first preferred embodiment of the present invention.

FIG. 2 is a sectional view of the first preferred embodiment of the present invention.

FIG. 3 is a sectional view of a part of the first preferred embodiment of the present invention.

FIG. 4 is a system block diagram of the first preferred embodiment of the present invention.

FIG. 5 is another system block diagram of the first preferred embodiment of the present invention.

FIG. 6 is similar to FIG. 2, illustrating that the air flows through the air passage to exhaust the heat from the heat-dissipating member.

FIG. 7 is similar to FIG. 6, illustrating that the cooling fan functions to reinforce the upward flow of the airflow to enhance the thermal dissipation of the heat-dissipating member.

FIG. 8 is a sectional view of a second preferred embodiment of the present invention.

FIG. 9 is a sectional view of a second preferred embodiment of the present invention at work.

FIG. 10 is a sectional view of a third preferred embodiment of the present invention.

FIG. 11 is a sectional view of a part of a third preferred embodiment of the present invention.

### DETAILED DESCRIPTION OF PREFERRED EMBODIMENTS

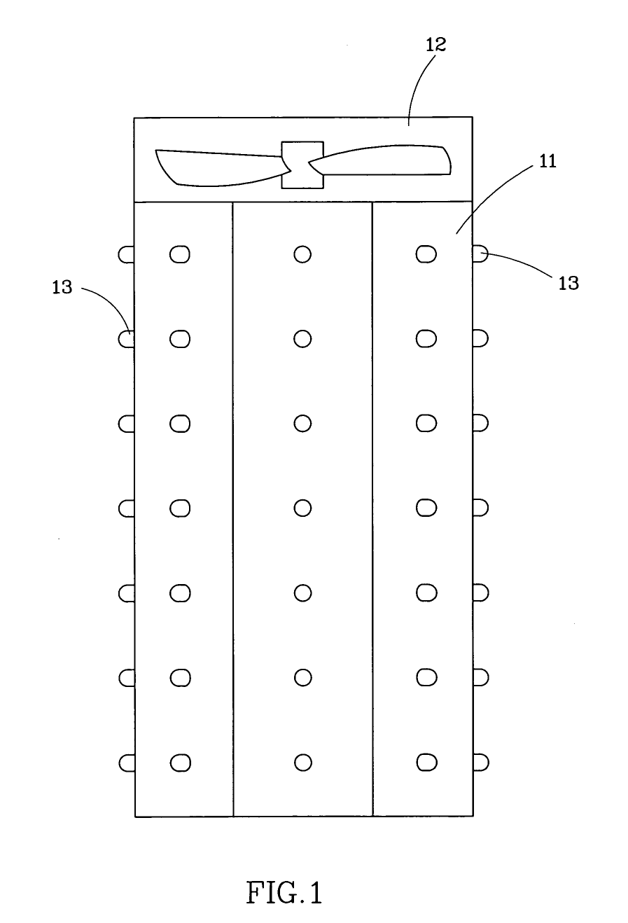

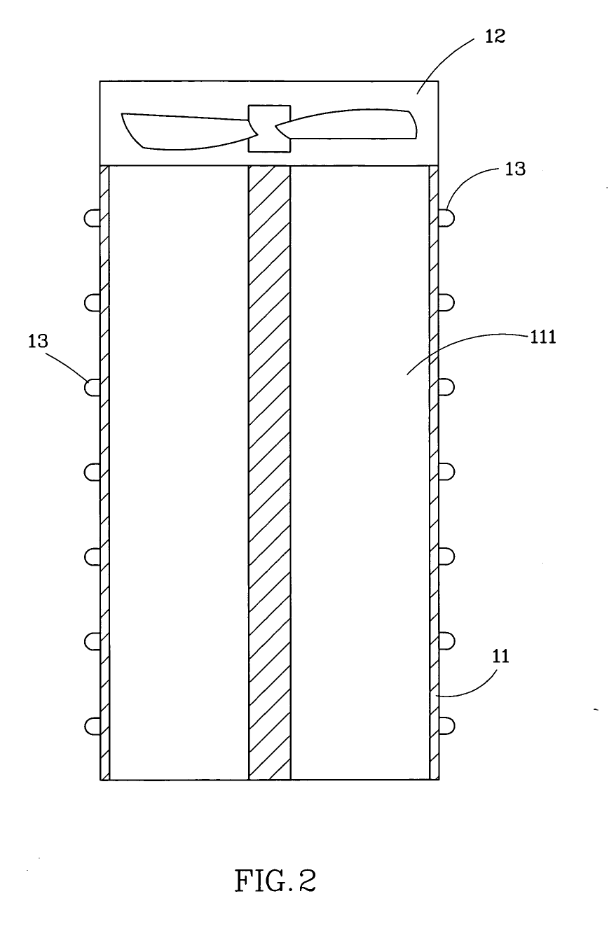

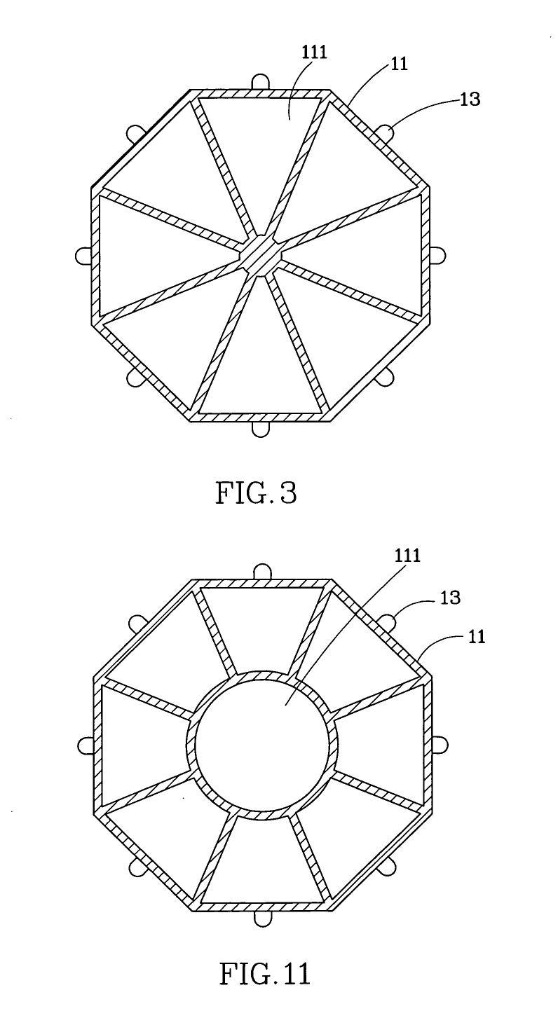

Referring to FIGS. 1-5, an LED lamp constructed according to a first preferred embodiment of the present invention is composed of a heat-dissipating member 11, a cooling fan 12, a plurality of LEDs 13, and a controller 14. The heat-dissipating member is columnar, including a plurality of air passages 111 axially running through an inside thereof. The cooling fan 12 is mounted to the heat-dissipating member 11 and to top ends of the air passages 111. When the cooling fan 12 is driven, the airflow goes upward. The LEDs 13 are disposed on a surface of the heat-dissipating member 11 axially along the heat-dissipating member 11. The controller 14 is electrically connected with the cooling fan 12 and the LEDs 13 for enabling the cooling fan 12 to drive airflow to flow upward and for driving the LEDs to light up.

In this embodiment, the controller 14 includes a temperature sensor 141 and a control circuit 142. The temperature sensor 141 can detect the temperature of the heat-dissipating member 11. The control circuit 142 is electrically connected with the cooling fan 12, the temperature sensor 141, and the LEDs 13 for receiving signals of temperature from the temperature sensor 141. When the temperature of the heat-dissipating member 11 goes beyond a predetermined one, the control circuit 142 can activate the cooling fan 12 to drive the airflow to flow upward and enable the LEDs 13 to light up.

Referring to FIG. 5, the controller 14 can alternatively be a delay circuit 143 electrically connected with the cooling fan 12 and the LEDs 13 for controllably activating the cooling fan 12 after the LEDs 13 light up for a predetermined duration, like five or ten minutes, and for controllably enabling the LEDs 13 to light up.

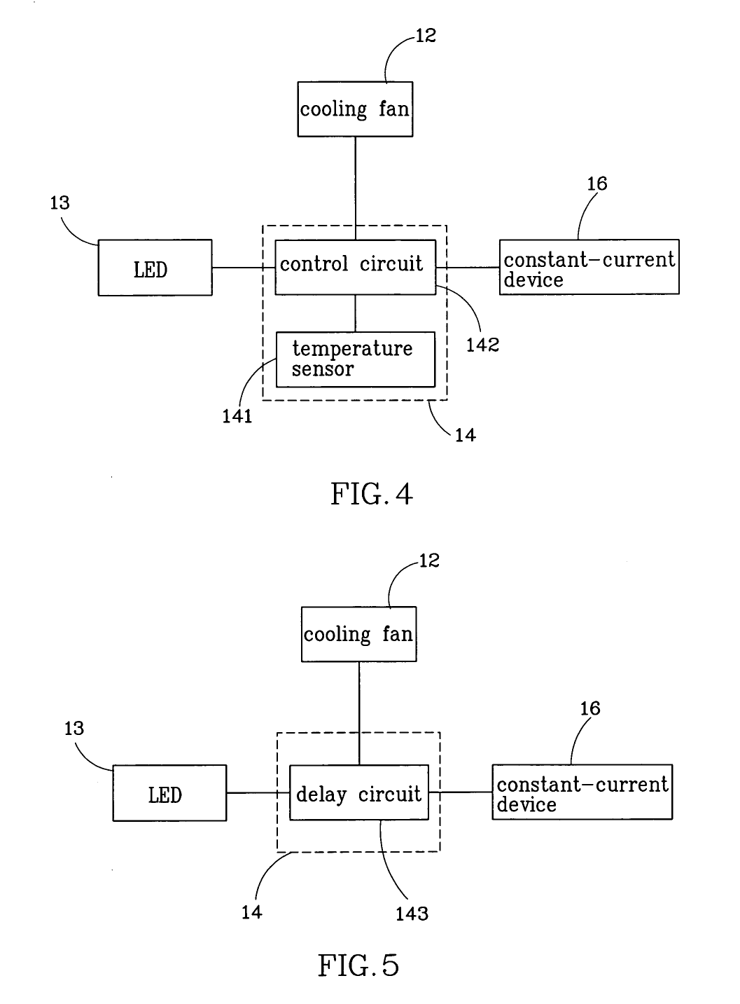

Referring to FIGS. 4 and 5, the LED lamp can further include a constant-current device 16 electrically connected with the control circuit 142 or the delay circuit 143 for providing constant current in such a way that the working time of relevant electronic components can be elongated.

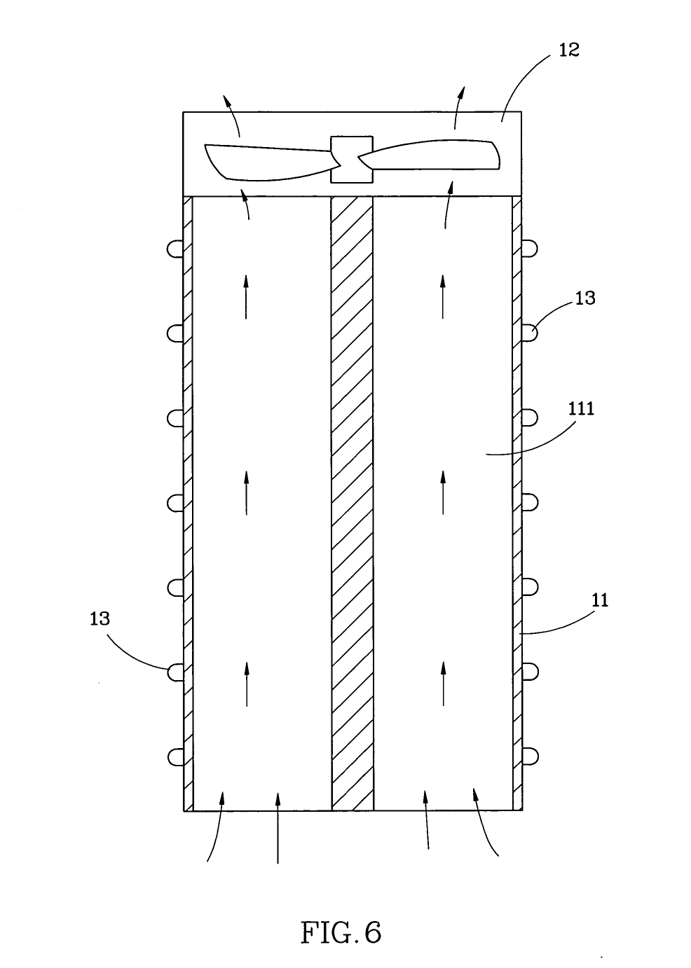

Referring to FIG. 6, while the LED lamp is working, the control circuit 142 or the delay circuit 143 makes the electric current of the constant-current device 16 be electrically connected with the LEDs 13 to enable illumination of the LEDs 13. The LEDs 13 generate heat while lighting up and then the heat is conducted to the heat-dissipating member 11. Because the heat-dissipating member 11 includes the air passages 111, the air located in the air passages 111 flows upward due to the heat conducted to the heat-dissipating member 11. In the meantime, the air located below the air passages 111 flows upward to generate natural convection and then the heat can be taken outside. Thus, the heat-dissipating member 11 can thermally dissipate the LEDs 13. The air can pass through the air passages 111 to be taken outside because the flow resistance in the air passages 111 is lower than that of the conventional fins. Thus, the efficiency of the thermal dissipation of the present invention is higher than that of the prior art.

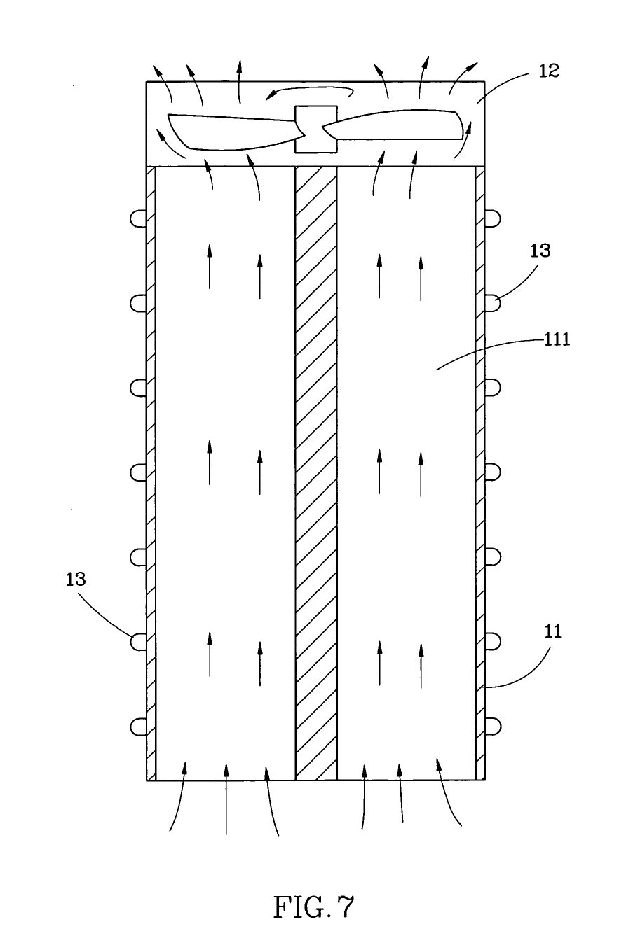

Referring to FIG. 7, the LEDs 13 keeps illumination and then transfer the heat to the heat-dissipating member 11, or the heat-dissipating member 11 is heated externally, such that the temperature of the heat-dissipating member 11 keeps rising. Under the circumstances, the LED lamp 11 of the first embodiment can come up with the following two manners of thermal dissipation.

First, the temperature sensor 141 keeps detecting the temperature of the heat-dissipating member 11 and transmitting the signals of temperature to the control circuit 142. When the temperature of the heat-dissipating member 11 is higher than a predetermined one, the control circuit 142 makes the constant-current device 16 be electrically connected with the cooling fan 12 to drive the cooling fan 12 to amplify the upward flowage of the airflow in such a way that the efficiency of thermal dissipation of the heat-dissipating member 11 is enhanced. Besides, the control circuit 142 keeps electric connection between the constant-current device 16 and the cooling fan 12 until the control circuit 142 deactivates the electric connection between the constant-current device 16 and the LEDs 13.

Second, while the delay circuit 143 is electrically connected with the constant-current device 16 and the LEDs 13, it starts to keep time. When a predetermined time point is reached, the cooling fan 12 is activated to reinforce the thermal dissipation of the heat-dissipating member 11 until the delay circuit 142 deactivates the electric connection between the constant-current device 16 and the LEDs 13.

In light of the above two manners, while the heat-dissipating member 11 keeps absorbing the heat to heighten the temperature thereof, the cooling fan 12 can keep running to intensify the upward flowage of the air to further enhance the thermal dissipation of the heat-dissipating member 11. Compared with the prior art, when external heat is transferred to the LEDs 13, the present invention can still keep thermal dissipation.

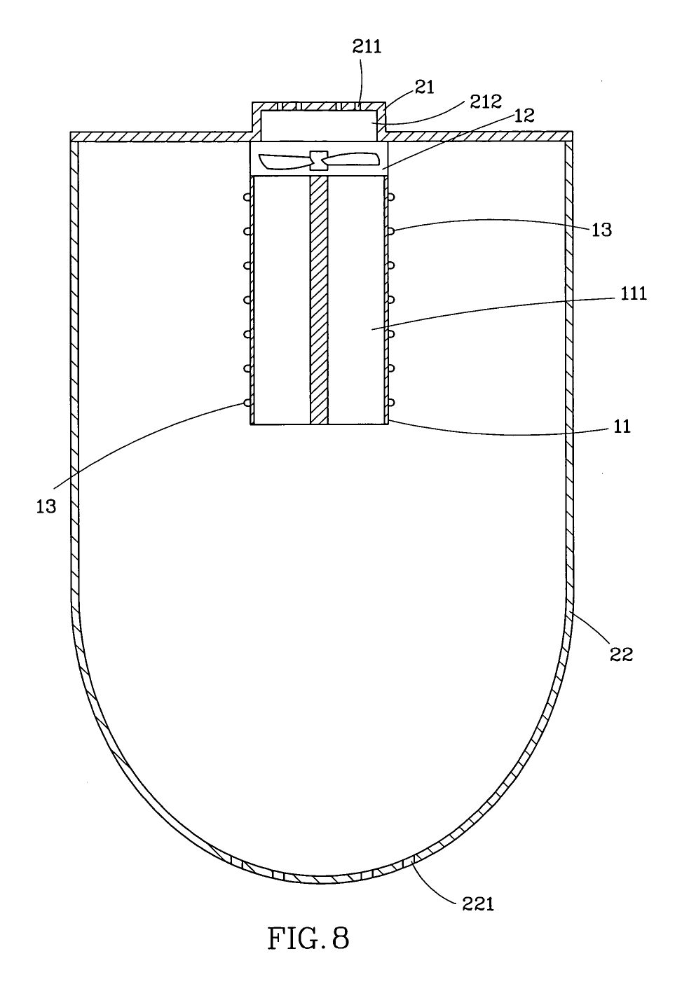

Referring to FIG. 8, an LED lamp constructed according to a second preferred embodiment of the present invention is similar to and different from that of the first embodiment as recited below.

The LED lamp further includes a lamp holder 21 and a lamp cover 22. The lamp holder 21 at a bottom side thereof is fixed to the cooling fan 12, having a plurality of louvers 211 and a thermal passage 212. The louvers 211 are formed on a top side of the lamp holder 21 for heat to exhaust therethrough. The thermal passage 212 is in communication with the louvers 211. The lamp cover 22 is covered on the LEDs 13 and fixed to the lamp holder 21, having a plurality of pores 221 running therethrough, for preventing an external object from colliding with the LEDs 13 and for generating visual effect of diffusion of the rays emitted by the LEDs 13. The pores 221 are for the air to pass therethrough into the lamp cover 22.

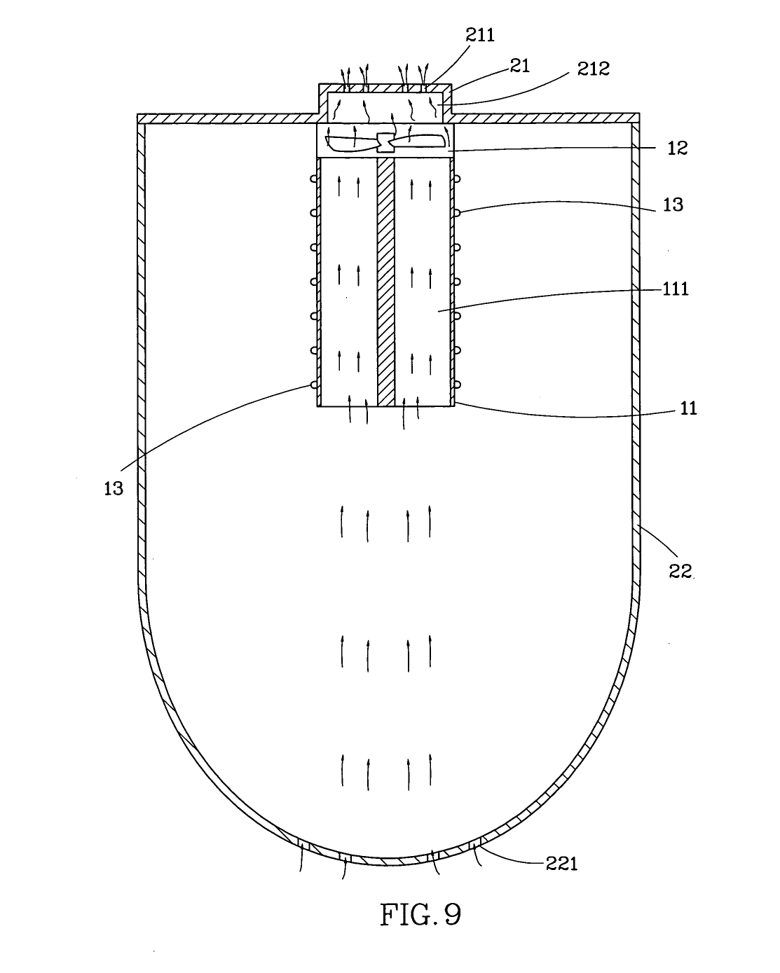

Referring to FIG. 9, an LED lamp constructed according to a second preferred embodiment of the present invention is similar to that of the first embodiment, having the following difference. The air passes through the pores 221 into the lamp cover 22 and then the heat of the heat-dissipating member 11 is transferred to the air while passing through the air passages 111, such that the air becomes hot. Next, the hot air passes by the cooling fan 12 and through the thermal passages 212 and then exhausts outside through the louvers 211. Therefore, the heat-dissipating member 11 thermally dissipates the LEDs 13.

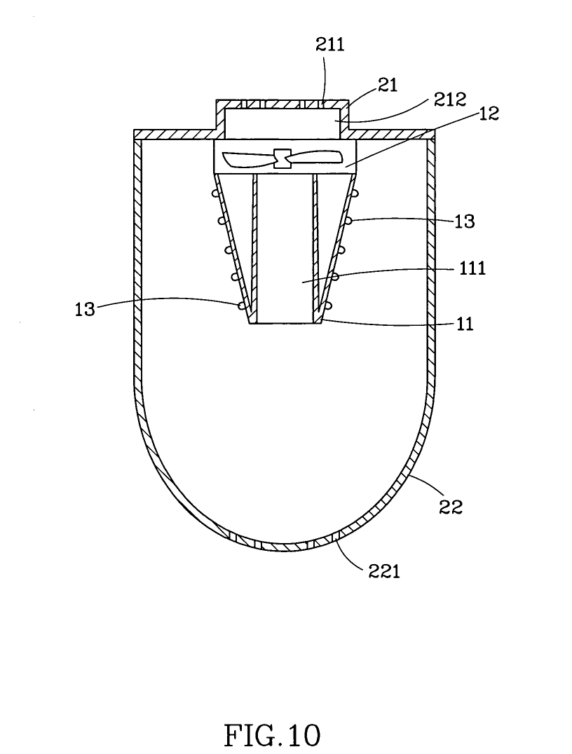

Referring to FIGS. 10 and 11, an LED lamp constructed according to a third preferred embodiment of the present invention is similar to that of the second embodiment, having the following difference. There is only one air passage 111 and the heat-dissipating member 11 is taped-shaped to have its upper side be larger than its lower side in diameter. In this way, the light of the LEDs 13 can emitted downward to enhance the brightness of the LED lamp. The operation of the third embodiment is identical to that of the second embodiment, so no more recitation in this regard is necessary.

In conclusion, the present invention includes the following advantages.
1. It makes good use of the air for passing through the air passages 111 to enable more efficient thermal dissipation.
2. The cooling fan 12 is activated to drive the airflow upward to further enhance the thermal dissipation of the heat-dissipating member 11, such that the heat-dissipating member 11 still keeps thermal dissipation while the external heat is transferred to the LEDs.

Although the present invention has been described with respect to specific preferred embodiments thereof, it is no way limited to the details of the illustrated structures but changes and modifications may be made within the scope of the appended claims.

What is claimed is:

1. An LED lamp comprising:
a columnar heat-dissipating member having at least one air passage axially running therethrough;
a cooling fan mounted to the heat-dissipating member and a top end of the at least one air passage;
at least one LED mounted to a surface of the heat-dissipating member; and
a controller electrically connected with the cooling fan and the at least one LED for enabling the cooling fan to drive an airflow to flow upward and for enabling the at least one LED to light up.

2. The LED lamp as defined in claim 1, wherein the controller comprises a temperature sensor and a control circuit, the temperature sensor being capable of detecting temperature of the heat-dissipating member, the control circuit being electrically connected with the cooling fan, the temperature sensor, and the least one LED for receiving signals of temperature from the temperature sensor, enabling the cooling fan to drive the airflow to flow upward, and enabling the at least LED to light up.

3. The LED lamp as defined in claim 2 further comprising a constant-current device, wherein the constant-current device is electrically connected with the control circuit for providing constant electric current.

4. The LED lamp as defined in claim 1, wherein the controller is a delay circuit electrically connected with the cooling fan and the at least one LED for enabling the cooling fan to drive the airflow to flow upward and enabling the at least one LED to light up.

5. The LED lamp as defined in claim 4, wherein the constant-current device is electrically connected with the delay circuit for providing constant electric current.

6. The LED lamp as defined in claim 1, wherein the at least one LED is plural and the LEDs are axially disposed on a surface of the heat-dissipating member.

7. The LED lamp as defined in claim 1 further comprising a lamp holder, wherein the lamp holder at its bottom side is fixed to the cooling fan and has a plurality of louvers and a thermal passage, the louvers being formed on a top side of the lamp holder for hot air to exhaust, the thermal passage being in communication with the louvers.

8. The LED lamp as defined in claim 7 further comprising a lamp cover, wherein the lamp cover has a plurality of pores running therethrough, the lamp cover being covered on the at least one LED and fixed to the lamp holder for preventing an external object from colliding with the at least one LED and for generating visual effect of diffusion of rays emitted by the at least one LED.

9. The LED lamp as defined in claim 8, wherein the at least one LED is plural and the LEDs are axially disposed on a surface of the heat-dissipating member.

10. The LED lamp as defined in claim 1, wherein the heat-dissipating member is taper-shaped to have its upper side be larger than its lower side in diameter.
